(19) United States
(12) Patent Application Publication
(10) Pub. No.: US 2002/0075433 A1
(43) Pub. Date: Jun. 20, 2002

(54) Liquid crystal display device

(76) Inventors: Tetsuya Nishio, Chiba-shi (JP); Setsuo Kobayashi, Mobara-shi (JP); Shigeru Matsuyama, Mobara-shi (JP); Teruo Kitamura, Hitachinaka-shi (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/988,198

(22) Filed: Nov. 19, 2001

Related U.S. Application Data
(63) Continuation of application No. 09/405,086, filed on Sep. 27, 1999, now abandoned.

(30) Foreign Application Priority Data
Sep. 25, 1998 (JP) 10-271555

(51) Int. Cl. G02F 1/1337

(52) U.S. Cl. 349/124

(57) ABSTRACT

In a liquid crystal display device comprising, a pair of substrates, a liquid crystal layer interposed between the pair of substrates, and at least one alignment film formed on a surface thereof confronting the liquid crystal layer, an optical property of the liquid crystal display device is improved by providing a moderate elasticity to the alignment film. In one of the liquid crystal display devices, the alignment film indicates a modulus of elasticity of not less than 2 GPa (2×10⁹N/m²) being measured with a measurement error of ±GPa at temperature of 55° C., including a fluctuation of ±5° C. According to this property of the alignment film, sticking images appearing in and deteriorating the display quality of the liquid crystal display device are drastically suppressed.

### CROSS REFERENCE TO RELATED APPLICATION

This is a continuation of U.S. application Ser. No. 09/405,086, filed Sep. 27, 1999, the subject matter of which is incorporated by reference herein.

### BACKGROUND OF THE INVENTION

The present invention relates to liquid crystal display devices, and specifically, to an improvement in the alignment films thereof.

Liquid crystal display devices are in wide use as devices for displaying several types of images, including both static and dynamic pictures.

The typical liquid crystal display device has a liquid crystal display panel comprising a pair of substrates, at least one of which is formed of a material having a sufficient optical transmissivity, such as glass, and a liquid crystal layer interposed between the pair of substrates. An electrode is provided for each pixel of the liquid crystal display panel, and the orientation directions of the liquid crystal molecules in the liquid crystal layer are controlled by an electrode provided for each of the pixels. The liquid crystal display devices of this kind are classified into either “a passive-matrix type”, in which the respective pixels are turned on and off by applying voltages to the electrodes selectively, or “an active-matrix type”, in which an active element (switching element) is provided for each pixel thereof and the respective pixels are turned on and off by selecting the active elements associated therewith. The liquid crystal display device of the active-matrix type has the advantages of a good contrast ratio and a high speed video response.

Liquid crystal display devices of the active-matrix type have utilized a so-called vertical electric field scheme (called TN—Twisted Nematic—scheme), in which an electric field is applied between an electrode formed on one of the pair of substrates and another electrode formed on the other of the pair of substrates for changing the orientation directions of the liquid crystal molecules in the liquid crystal layer. However, liquid crystal display devices utilizing a so-called lateral electric field scheme (called IPS—In Plane Switching—scheme), in which an electric field is applied to the liquid crystal layer in a substantially parallel direction relative to a main surface of at least one of the pair of substrates, has been developed.

The liquid crystal display device of the lateral electric field type, in which comb-teeth like electrodes are formed on one of the pair of substrates so as to obtain an exceedingly wide viewing angle, is known (see, Japanese Patent Publication No. Sho 63-21907 (JP-B-21907/1988) and U.S. Pat. No. 4,345,249).

### SUMMARY OF THE INVENTION

However, a phenomena involving sticking of images (sticking image) tends to appear in the lateral electric field-type liquid crystal display device.

The liquid crystal display device divides a potential difference of a driving voltage (a driving voltage difference, hereinafter) being applied between the electrodes into units called “tone (gray scale)”, and operates to modulate the brightness of an image to be displayed in accordance with such tones. With an increase of the driving voltage difference, the optical transmissivity of each of the pixels disposed in the liquid crystal display panel will either increase (in a Normally-Black mode) or decrease (in a Normally-White mode), and the relationship between the driving voltage difference and the optical transmissivity is expressed by a transmissivity curve. Therefore, the optical transmissivity of a pixel is determined as a value of the transmissivity curve which corresponds to the driving voltage difference, corresponding to the predetermined tone, which is applied between the electrodes thereof.

A potential difference for each of the tones is about 20 mV, and remains only around 0.25% of a maximum value of the driving voltage when the maximum value is 8V. Assuming the maximum value of the driving voltage as a potential difference of the driving voltages for displaying the pixel as white and as black, the relative optical transmissivity of a pixel varies between 0-100% in accordance with a variation of the driving voltage in a range of 8V. When an image is displayed by a driving voltage close to 0V, an optical transmissivity error of 0.6% appearing on the transmissivity curve with respect to a predetermined tone (driving voltage) makes the optical transmissivity of the pixel correspond to another tone far beyond the predetermined tone, so that the brightness of the image becomes uneven and tones of colors therein are reversed. Such a condition is called the “sticking image” phenomenon.

This sticking image phenomenon tends to appear at a higher temperature (55° C.) rather than at a normal room temperature (25° C.). The sticking image is evaluated on the basis of differences between brightness values measured in the liquid crystal display devices and that determined in accordance with the optical transmissivity given by the transmissivity curve in accordance with the driving voltage applied thereto.

The present invention has been made in view of the technical background mentioned above, and an object of the invention is to provide an improved liquid crystal display device which is suitable for suppressing. the sticking image phenomenon.

Some representative aspects of the present invention as disclosed herein will be briefly summarized as follows.

The present invention provides improvement in an alignment film being utilized for a liquid crystal display device comprising a pair of substrates and a liquid crystal layer interposed therebetween. At least one of the substrates has an alignment film on a surface thereof at a side of (confronting) the liquid crystal layer. The liquid crystal display device according to the present invention has at least one of the following features, for example:

(1) an alignment film exhibits an elasticity modulus of not less than 2 GPa (2×10⁹N/m²) as measured with a measurement error of ±1 GPa at a temperature of 55° C. including fluctuation of ±5° C.;

(2) an alignment film exhibits an elasticity modulus of not less than 1.8 GPa (1.8×10⁹N/m²) as measured with a measurement error of ±0.01 GPa at a temperature of 55° C. including a fluctuation of ±5° C.;

(3) an alignment film includes at least one polycrystalline region formed therein, and the polycrystalline region contains crystal grains of at least one polymeric material which is utilized as an ingredient of the alignment film.

According to at least one of these three features, the alignment film exhibits a relatively large modulus of elasticity, so that movements of liquid crystal molecules in the vicinity of (esp. in contact with) the alignment film in response to an electric field are not affected by the alignment film.

Features other than (1)-(3) are:

(4) an optical characteristic thereof indicates that a difference between optical transmissivities in accordance with a driving voltage supplied thereto for increasing the driving voltage and for decreasing the driving voltage does not exceed 0.6%, while a measurement error for each of the optical transmissivities is ±0.01% or less; and

(5) an optical characteristic thereof indicates that a relative optical transmissivity difference which is determined as a deviation ratio of the optical transmissivity for decreasing the driving voltage supplied thereto to that for increasing the driving voltage in accordance with the driving voltage does not exceed 6%, while a measurement error for each of the optical transmissivities is ±0.01% or less.

According to at least one of these five features (1)-(5), hysteresis of an optical transmissivity of the liquid crystal display panel based on a difference in the behavior of liquid crystal molecules between a status thereof where it is driven by an electric field and where it gets back to normal is reduced drastically, so that the sticking image phenomenon appearing in a screen of the liquid crystal display panel is suppressed.

These and other objects, features and advantages of the present invention will become more apparent from the following description when taken in conjunction with the accompanying drawings.

### BRIEF DESCRIPTION OF THE DRAWINGS

FIG. 1 is a graph showing experimental results in the form of optical characteristics of a liquid crystal display panel according to the present invention;

FIG. 2 is a schematic diagram showing an outline of the structure of the liquid crystal display device according to the present invention;

FIG. 3(a) is a diagram illustrating a planar configuration and FIGS. 3(b) and 3(c) are diagrams illustrating cross sectional configurations of one of the pixel regions of the liquid crystal display device;

FIG. 4 is a diagram used for explaining the relationship between the orientation directions of the alignment films and the bending directions of the liquid crystal molecules;

FIG. 5 is a graph showing experimental results in the form of optical characteristics of a conventional liquid crystal display panel;

FIGS. 6(a) to 6(d) are diagrams showing molecular structures of polymeric materials suitable for the alignment film;

FIG. 7 is a schematic diagram of the measuring system utilized for evaluating optical characteristics of a liquid crystal display; and

FIGS. 8(a) and 8(b) are diagrams of an atomic force microscope for measuring the modulus of elasticity of the alignment film.

### DETAILED DESCRIPTION

An embodiment of the liquid crystal display device according to the present invention will be explained with reference to the accompanying drawings.

<Outline of the Structure of the Liquid Crystal Display Device>

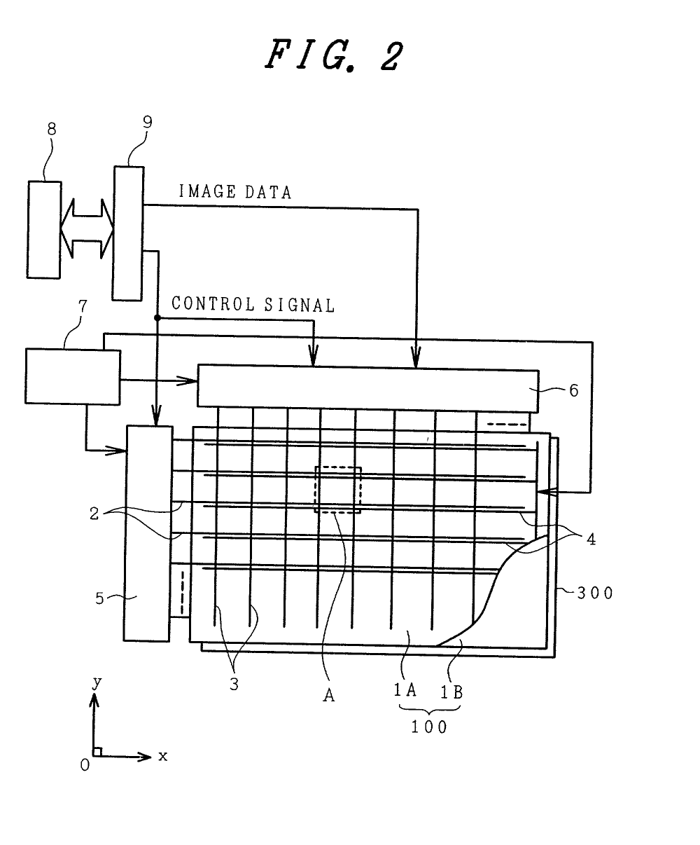

FIG. 2 shows the basic structure of a liquid crystal display device according to the present invention. In FIG. 2, a liquid crystal display panel 100 comprises a pair of substrates 1A, 1B which are disposed so as to confront one another, and a liquid crystal layer (not shown) is interposed between the pair of substrates. At least one of the pair of substrates 1A, 1B is a so-called transparent substrate, having sufficient optical transmissivity to allow light to go into or out of the liquid crystal layer. In this embodiment, transparent substrates are utilized for both of the pair of substrates.

On a surface at the liquid crystal layer side of one of the pair of substrates 1A, scanning signal lines 2 and counter voltage signal lines 4, both extending in the x-direction (row direction) are juxtaposed along the y-direction (column direction) transverse to the x-direction. Therefore, as seen in FIG. 2, lines, including a scanning signal line 2 and then a counter voltage signal line 4 disposed in the vicinity thereof, another scanning signal line 2 spaced relatively further from the previous counter voltage signal line 4, another counter voltage signal line 4 . . . , are disposed sequentially in this order from the upper side of the transparent substrate 1A.

Video signal lines 3 extending in the y-direction are juxtaposed along the x-direction and are electrically isolated from the scanning signal, lines 2 and the counter voltage signal lines 4. Pixels are formed in respective rectangular regions of the transparent substrate 1A, each of which is enclosed by a respective one of the scanning signal lines 2, a respective one of the counter voltage signal lines 4, and a pair of video signal lines 3. The pixels are arranged in the form of a matrix over the display plane of the liquid crystal display device. Color filters (explained later) of red, green, and blue are provided repeatedly in this order for pixels being juxtaposed in either the x-direction or the y-direction, and a group of respective ones of the red, green, and blue pixels composes an unit pixel utilized as one element for displaying a color image. The detailed structure of a pixel will be explained later.

The liquid crystal display device comprises a vertical scanning circuit 5 disposed as an external circuit relative to the liquid crystal display panel 100 for sequentially supplying scanning signals (voltages) to the respective scanning signal lines 2. The liquid crystal display device also comprises a video signal driving circuit 6 disposed as an external circuit relative to the liquid crystal display panel 100. The video signal driving circuit 6 supplies video signals (voltages) to the respective video signal lines in accordance with the timing of a scanning signal being supplied to the respective scanning signal lines.

The vertical scanning circuit 5 and the video signal driving circuit 6 each are supplied with electric power from a liquid crystal driving power supply circuit 7. Image information transmitted from a CPU 8 (Central Processing Unit, usually provided externally to the liquid crystal display device) is divided into display data and control signals in a controller 9 (usually included in the liquid crystal display device), and the display data and the control signals are inputted to the vertical scanning circuit 5 and the video signal driving circuit 6. To counter voltage signal lines 4 formed on the transparent substrate 1A, a counter voltage signal including, e.g. alternating current signals, are supplied from the liquid crystal driving power supply circuit 7.

<Structure of a Pixel Region>

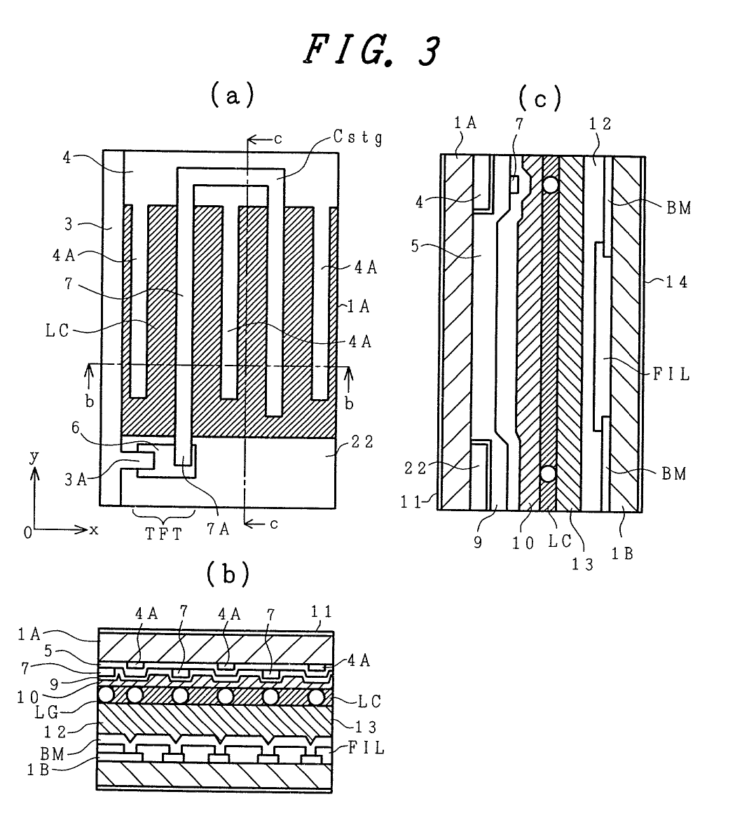

FIGS. 3(a) to 3(c) show an example of a pixel region, which is seen as being enclosed by a dotted frame A in FIG. 2. FIG. 3(a) is a plan view of the pixel region. FIG. 3(b) is a cross sectional view taken along a line b-b of FIG. 3(a); and FIG. 3(c) is a cross sectional view taken along a line c-c of FIG. 3(a).

As FIG. 3(a) shows, a region corresponding to one pixel is enclosed by one of the scanning signal lines 2 and one of the counter voltage signal lines 4 in the y-direction, and a pair of the video signal lines 3 adjacent to one another in the x-direction. In this example, the scanning signal lines 2 and the counter voltage signal lines 4 are formed at the same level and of the same material, i.e. by the same process. A counter electrode 4A is formed to be integrated with the counter voltage signal line 4, and for instance, three counter electrodes are provided for each pixel. Two of the three counter electrodes are disposed adjacent to the video signal lines 3 located at right and left sides of the pixel region of FIG. 3(a), and they extend in the y-direction. The remaining one of the counter electrodes 4A is disposed at a middle position between the other two of them and extends along the y-direction.

On a surface on which the scanning signal lines 2 and the counter voltage signal lines 4 (including the counter electrode 4A) are formed, an insulating film 5 is formed so as to cover these scanning signal lines and these counter voltage signal lines (including the counter electrodes). The insulating film 5 functions as an interlayer insulating film for isolating the video signal lines 3 from the scanning signal lines 2 and the counter voltage signal lines 4, as a gate insulating film for a thin-film transistor TFT in a region where the thin-film transistor is formed, and as a dielectric film for a capacitance element Cstg in a region where the capacitance element is formed.

The thin-film transistor is fabricated so as to overlap a part of the scanning signal line 2 covered by the insulating film. The thin-film transistor is fabricated by forming a semiconductor layer 6 (e.g. amorphous silicon: a-Si) on the insulating film covering part of the scanning signal line 2, and by forming a drain electrode 3A and a source electrode 7A on the semiconductor layer 6, spacing both of the electrodes from one another, and is completed as a MIS (Metal-Insulator-Semiconductor) transistor of so-called reversed staggered structure utilizing part of the scanning signal line 2 for the gate electrode thereof.

In this example, the drain electrode 3A and the source electrode 7A are formed at the same level and of the same material as used for the video signal line 3 and the pixel electrode 7, and these electrodes are formed in the same process thereas. Thus, the drain electrode 3A is fabricated by extending (branching off) a part of the video signal line 3 extending in the y-direction in FIG. 3(a) toward the thin-film transistor. The source electrode 7A is fabricated to be integrated with the pixel electrode 7. As FIG. 3(a) shows, the pixel electrode 7 comprises two portions disposed between respective pairs of the three counter electrodes 4A and extending in the y-direction and another portion which is disposed over the counter voltage signal line 4 and extends in the x-direction, so as to have a “U”-shape in which the former two portions (extending in the y-direction) join with the latter portion (extending in the x-direction) at respective (upper) ends thereof.

In an area where the pixel electrode 7 overlaps with the counter voltage signal line 4, the capacitance element Cstg, utilizing the insulating film 5 interposed between this pixel electrode 7 and this counter voltage signal line 4 as a dielectric film, is formed. The capacitance element Cstg allows the pixel electrode 7 to store image information for long time during a period in which the thin-film transistor TFT is turned off.

Into a surface of the semiconductor layer 6 of the thin-film transistor TFT which forms an interface with the drain electrode 3A or the source electrode 7A, phosphorus is doped for forming a n-type layer with high impurity concentration in the semiconductor layer around the surface. The drain electrode 3A and the source electrode 7A form ohmic contacts with the semiconductor layer 6 by way of this n-type layer. This example employs a process comprising the steps of forming the n-type layer over the whole region of an upper surface of the semiconductor layer 6, fabricating the drain electrode 3A and the source electrode 7A on the upper surface of the semiconductor layer 6, and etching the n-type layer utilizing the drain electrode and the source electrode as a mask so as to remove the portions of the n-type layer other than those formed in a region where the drain electrode and the source electrode are formed.

The transparent substrate 1A of the liquid crystal display panel 100 is finished by forming a protection film formed of a silicon nitride film, for example, on an upper surface of the insulating film 5 having the thin-film transistor TFT, the video signal lines 3, the pixel electrode 7 and the capacitance elements Cstg formed in the aforementioned manner, and by forming an alignment film 10 on an upper surface of the protection film 9. On the outer surface of the transparent substrate 1A, opposite to the liquid crystal layer LC side, a polarizing plate (polarizer) 11 is disposed.

As FIG. 3(b) shows, at a liquid crystal layer LC side of the transparent substrate 1B, which is disposed so as to confront the transparent substrate 1A, a light shielding, layer BM framing a displaying region for every pixel is formed. In the example of FIG. 3(b), the light shielding film BM is formed also so as to cover the counter electrodes 4A and the pixel electrode 7. The light shielding layer BM has both functions for preventing the thin-film transistor TFT from being irradiated by light directly and for improving the display contrast. Openings formed in the light shielding layer BM substantially define the pixel regions.

Color filters are fabricated for covering the respective openings of the light shielding layer BM. The respective color filters which correspond to the pixel regions disposed adjacent to each other in the x-direction have different colors from each other, and the boundaries therebetween are formed on the light shielding layer BM. On a surface where the color filters FIL are formed, a leveling 12 of a resin film or the like is formed, and an alignment film 13 is formed on the leveling layer 12. On the outer surface of the transparent substrate 1B, opposite to the liquid crystal layer LC side, a polarizing plate 14 is disposed.

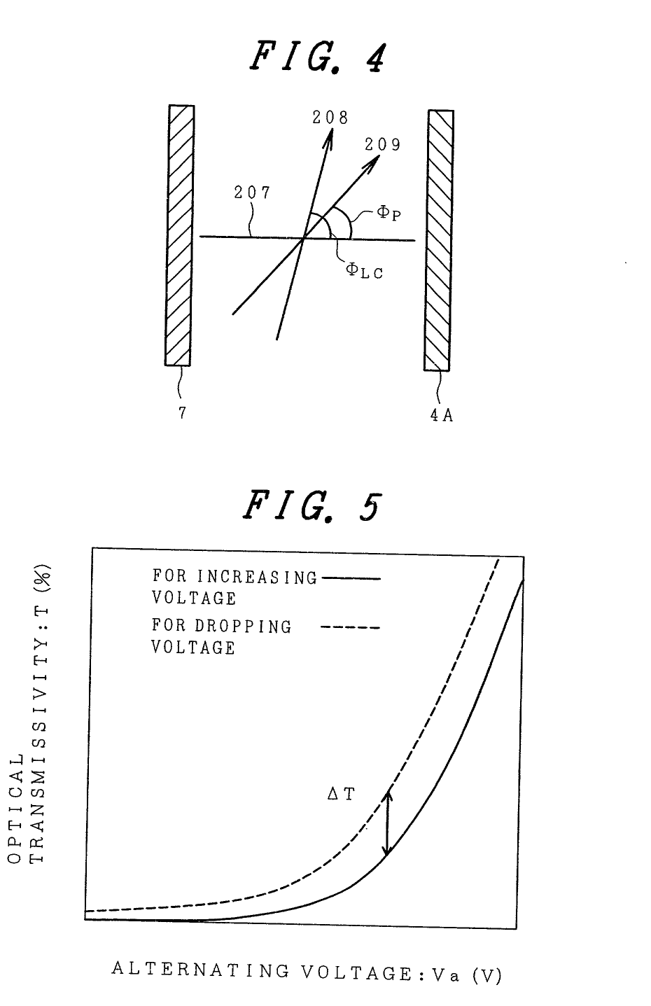

The relationships between the alignment film 10 formed on the substrate 1A and the polarizing plate 11, and between the alignment film 13 formed on the substrate 1B and the polarizing plate 14, will be explained with reference to FIG. 4. An angle between a rubbing direction 208 for both of the alignment films 10, 13 and a direction of an electric field 207 being applied between the pixel electrode 7 and the counter electrode 4A is shown as φLC. An angle between a polarization axis 209 of the polarizing plate 11 and the direction of the electric field 207 being applied between the pixel electrode 7 and the counter electrode 4A is shown as pP. (A polarization axis denotes a polarization plane of light passing through the polarizing plate). The polarization axis of the polarizing plate 14 is perpendicular to the polarization axis 209 of the polarizing plate 11. A nematic-type liquid crystal substance having a positive dielectric anisotropy Δε of 7.3 (1 kHz) and a refractive anisotropy An of 0.073 (589 nm, 20° C.) is utilized for the liquid crystal layer in this example.

The liquid crystal display device, comprising the alignment films 10, 13 and the polarizing plates 11, 14 in the relationships mentioned above, operates in a normally black mode, for example, so that the liquid crystal display device enables light to pass through the liquid crystal layer LC by generating an electric field substantially in parallel to the transparent substrate 1A in the liquid crystal layer LC thereof. Although a liquid crystal display device operating normally in the black mode is utilized for this example, a liquid crystal display device which operates normally in the white mode, in which the amount of light passing through a liquid crystal layer thereof has a maximum when no electric field is applied between a pixel electrode and a counter electrodes thereof, may be utilized as well.

<Alignment Film>

The alignment films 10, 13 are usually formed of synthetic resin films (plastic films). Each of the alignment films is processed for forming an alignment pattern on an upper surface thereof by rubbing treatment or the like. The alignment film determines initial orientations of the liquid crystal molecules in the liquid crystal layer in accordance with the alignment pattern thereof. In this embodiment, a polymeric material of the polyamic acid series (having a molecular weight of about 40,000) is utilized for the alignment film.

The fabrication process for the alignment film is as follows. First of all, by dissolving polymers of the polyamic acid series in a solvent (e.g. N-butyl-2pyrrolidone, butyrolactone, butylcellosolve, etc.), varnish for the alignment film is obtained. A ratio of the polymers of the polyamic acid series to the solvent being used is set, for instance, as a weight ratio of the polymers of 18 wt %.

Next, by dripping the aforementioned varnish onto an upper surface of the protective film 9 (or, the leveling film 12) of the transparent substrate 1A (or 1B) while it is mounted on a spinner, and then by rotating the substrate at 2000 rpm for approximately 40 seconds on the spinner, the upper surface of the protective film 9 (or the leveling film 12) is coated with the varnish uniformly (spin coating).

After the spin coating, the transparent substrate being coated with the varnish is processed by a heat treatment at 80° C. for 5 minutes (i.e. pre-baking). Then, the transparent substrate is processed by a heat treatment at a temperature in the range from about 200° C. to about 260° C. for at least 10 minutes, preferably 20 minutes or more (i.e. baking or stoving). Due to these heat treatments, the solvent hardly remains in the film (a coating film, hereinafter) formed by applying the varnish to the upper surface of the protection film 9 (or the leveling film 12). By processing a surface of the coating film with a rubbing treatment along a direction in which the liquid crystal molecules should be oriented initially thereon, the alignment film 11 (or 13) is finished.

Each of the alignment films 10,13 being fabricated by the process mentioned above has a relatively large modulus of elasticity. Therefore, influences of the alignment film on the behavior of the liquid crystal molecules in response to an electric field applied thereto are reduced. While the liquid crystal molecules being driven (the orientation direction thereof being changed) by the electric field applied thereto return to an initial position (an initial orientation direction, usually under a no electric field condition), the influence of the alignment film is suppressed significantly.

The liquid crystal molecules in the liquid crystal layer LC are twisted in response to the electric field being applied thereto, and the optical transmissivity of the liquid crystal layer varies in accordance with the amount of the twist of the liquid crystal molecule. If the twisting variations of the liquid crystal molecules between a predetermined range of the electric field differ between a state of increasing the electric field to a state of decreasing the electric field, hysteresis appears in the optical transmission property of the liquid crystal layer with respect to the electric field. Especially for the liquid crystal display device of the lateral electric field type, the amount of twisting of the liquid crystal molecules depends directly on the electric field applied thereto. Therefore, the sticking image phenomenon which is generated by such hysteresis becomes a problem.

The alignment film fabricated by the aforementioned processes has a sufficient elasticity for suppressing the influence thereof on the behavior of the liquid crystal molecules in response to the electric field. By providing such a sufficient elasticity for the alignment layer, the surface of the alignment film does not follow the motions of the liquid crystal molecules. Therefore, regardless of whether the electric field intensity increases or decreases, the liquid crystal molecules are twisted in response to the electric field with a high repeatability and will follow the orientation directions thereof with respect to the intensity of the electric field precisely. Especially for a liquid crystal display device of the lateral electric field type, the an alignment layer having the elasticity mentioned above is effective for reducing the sticking image phenomenon. This effect is has been evidenced experimentally as a suppression of image retention during the changing of images. Moreover in this experiment, visible sticking images are hardly generated to an extent of being observed, and if they appear, they fade out within a few minutes.

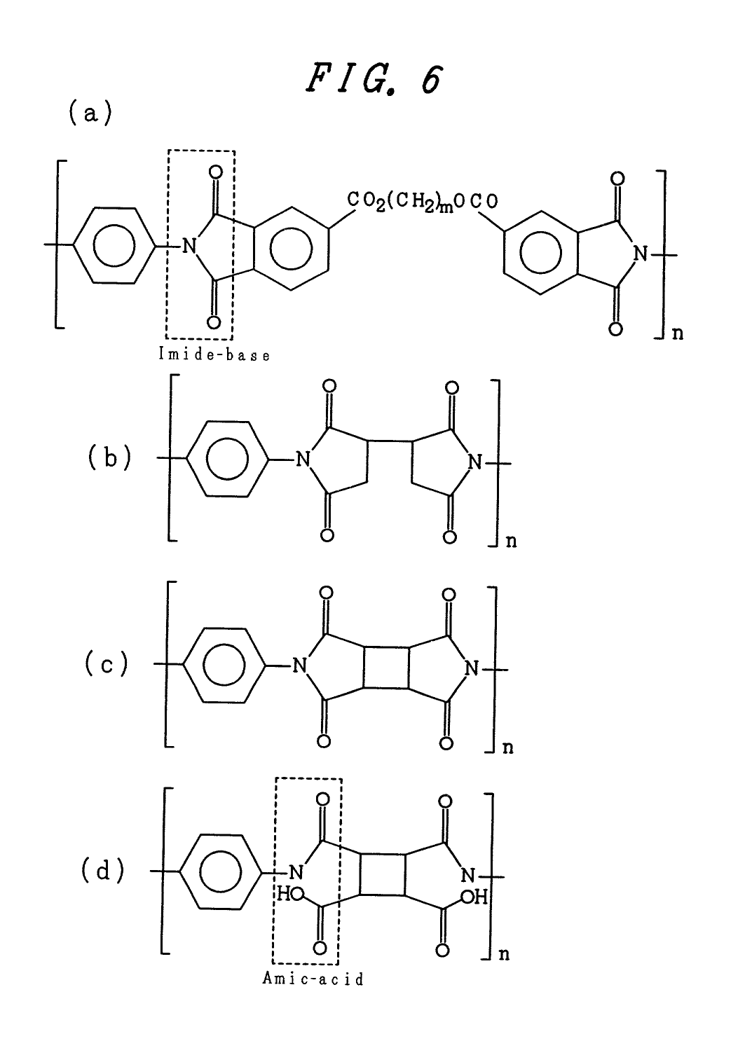

An alignment layer having such an elasticity as mentioned above also may be obtained by irradiating the coating film with light (photon beam). This sort of the alignment film can be realized not only by the use of polymeric materials of the polyamic acid series, as mentioned above, but also polymeric materials of polyimide and polymeric materials of polyamide. Four examples of the polymeric materials utilized for this alignment film are shown in FIGS. 6(a)-6(d). FIGS. 6(a)-6(c) show polymeric materials of the polyimide series, and the material of FIG. 6(b) in which the distance between imide bases is shorter than that of the material of FIG. 6(a) is preferable to fabricate the alignment layer mentioned above. Moreover, the material of FIG. 6(c) which connects imide bases thereof by a pair of single bonds is preferable to fabricate the alignment layer mentioned above in comparison with the material of FIG. 6(b). For providing moderate elasticity for an alignment film, it is preferable to reduce the rotations around axes of chemical bonds in a polymeric material forming the alignment film. FIG. 6(d) shows a polymeric material of the polyamic acid series having a similar structure to that of the polymeric material of FIG. 6(c). In the view of the molecular structure mentioned above, the polymeric material of FIG. 6(d) is a preferable ingredient for fabricating the alignment film having a moderate elasticity.

Another point to be considered for providing moderate elasticity for an alignment film is the removal of the solvent at the steps of pre-baking and baking in the aforementioned process. For one of the conventional examples, the pre-baking step is held at 70° C. for 50-60 seconds, and the baking step is held at 230° C. for 8 minutes. In each of these steps, a certain period is required to allow the whole substrate being processed to reach the required temperature during the heat treatment. For instance, the certain period may be up to 5 minutes under the condition of the aforementioned conventional baking step, so that only a 3 minute period for keeping the whole of the substrate at exactly 230° C. remains. Therefore, solvents contained in a varnish (a precursor material for the alignment film) remain in the alignment layer after these heat treatments, so that the alignment film hardly obtains a sufficient elasticity. However, by setting at least one of the pre-baking period and the baking period longer than that for the conventional step in the aforementioned process, the amount of the solvent remaining in the alignment film after the heat treatments is reduced sufficiently to allow the alignment film to obtain a moderate elasticity. The periods for the heat treatments, for instance, should be equal to 3 minutes or more for the pre-baking step, and equal to 10 minutes or more for the baking step. As for the baking step, which is carried out under a higher treatment temperature than the pre-baking step, it should be noticed exceedingly long period for the heat treatment. One of the criteria calls for setting the heat treatment period within 40 minutes. The heat treatment periods mentioned above are based on the heat treatment conditions being conventionally employed, and the other conditions (temperatures, etc.) may be modified in accordance with the sort of varnish to be utilized for fabricating the alignment layers.

One of the methods for determining whether the alignment film has the desired moderate elasticity or not involves an evaluation of the crystallinity thereof. The degree of crystallinity of the alignment film is evaluated, for instance; by X-ray diffraction. A photograph of the X-ray diffraction of an alignment film having the aforementioned moderate elasticity shows ring shaped patterns called a Debye-ring. Therefore, the alignment film contains a region in which a plurality of crystal grains of the aforementioned polymeric material are oriented randomly (i.e. a polycrystated region). The elasticity of the alignment film is also evaluated by the density thereof.

The physical properties of the alignment film mentioned above will be considered. In the following experiments, an alignment film 10 (or 13) formed in the liquid crystal display device was peeled away and was utilized as a specimen to be examined. Each measured value of temperature includes a permissible error of ±5° C., and each modulus of elasticity in the experimental results includes a permissible error of 1 GPa in the following explanations.

<Physical Properties of the Alignment Film 1>

As mentioned above, an alignment film was formed of an alignment film varnish which was prepared by dissolving polyamic acid having a molecular weight of 40,000 as an ingredient thereof in solvent in a weight ratio of 18 wt %. As a result of measuring the thickness of the alignment film using a probe-type thickness gauge, the thickness thereof was found to be about 13 μm.

As a result of measuring the modulus of elasticity of the alignment film with a dynamic tensile elasticity gauge, the modulus of elasticity thereof was 2 GPa (2×10⁹N/m²) at a temperature of 55° C. The measurement conditions were: the alignment film was 40 nm in length and 4 nm in width, and the frequency of vibrated oscillation thereof was 10% and the dynamic stress thereof was 1%, and measurements were performed in a humidity of 60%. As a result of measuring the modulus of elasticity of the alignment film while varying the temperature between −50° C. to 270° C., it was proved that the modulus of elasticity of the alignment film does not stay at the aforementioned value, but decreases as the temperature goes up.

However, it was ascertained that, when the alignment film has a modulus of elasticity of 2 GPa (2×10⁹N/m²) at a temperature of 55° C., no sticking image is visible on the screen of the liquid crystal display panel, and the display quality thereof is improved. Moreover, it was also ascertained that the modulus of elasticity of the alignment film not only should be 2 GPa (2×10⁹N/m²), but also may be greater than this value. This is based on the fact that, as the modulus of elasticity becomes greater, the magnitude of the sticking phenomenon visible on the screen decreases. Thus, alignment films having a modulus of elasticity as high as 2.5 GPa (2.5×10⁹N/m²), 3 GPa (3×10⁹N/m²), 3.5 GPa (3.5×10⁹N/m²), 4 GPa (4×10⁹N/m²), 4.5 GPa (4.5×10⁹N/m²), 5 GPa (5×10⁹N/m²), . . . at a temperature of 55° C. may be utilized as well.

<Physical Properties of the Alignment Film 2>

While the sticking image problem which this embodiment intends to solve has the tendency of increasing (deteriorating the display quality) at a high temperature rather than a normal temperature, evaluations of the sticking phenomenon at a high temperature (55° C.) is preferable for grasping the behavior thereof in detail.

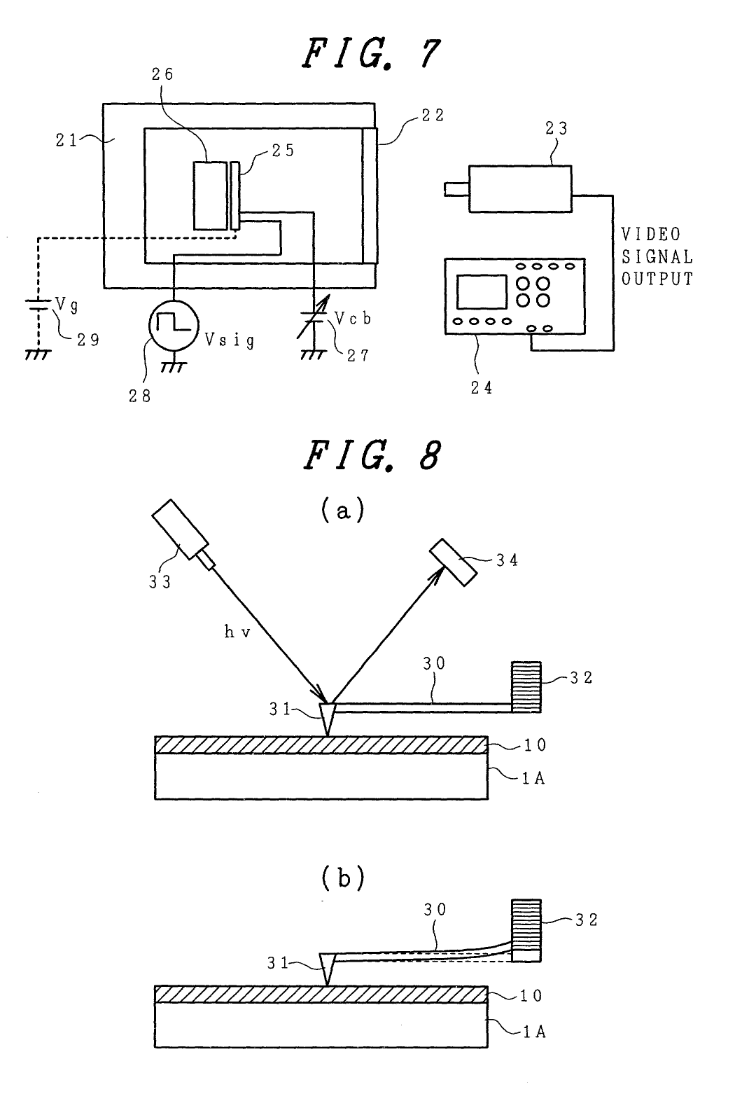

Under these circumstances, the magnitude of the sticking image problem before and after applying a driving voltage to the liquid crystal display panel at temperatures varying between 0 and 55° C. was evaluated as a difference appearing between the curves of T (Optical Transmissivity)−V (Driving Voltage) of the liquid crystal display panel for increasing and decreasing the driving voltage (hysteresis). FIG. 7 shows the basic structure of the measuring apparatus utilized for this experiment. A liquid crystal display panel 25 and a light source 26 are disposed in an isothermal chamber 21, and the atmosphere therearound is kept at a designated temperature. Light emitted from the light source 26 and passing through the liquid crystal display panel 25 passes out of the isothermal chamber 21 through a window 22 and is detected by a photo-multiplier 23. The detection intensity of the light is converted to a video signal, which is sent to a measuring regulator 24, and the measuring regulator 24 calculates the optical transmissivity of the liquid crystal display panel. The liquid crystal display panel 25 receives signals from a counter voltage signal source 27, which signals are applied to counter voltage signal lines thereof, signals from a signal voltage source 28, which are applied to video signal lines thereof, and signals from a gate voltage source 29, which are applied to scanning signal lines thereof, respectively.

At first, in the experiment, the light source 26 was turned on during 1 hour, and the brightness thereof was stabilized. Next, the isothermal chamber 21 was set at a designated temperature in a range between −30° C. and 55° C., and the liquid crystal display panel 25 was left in the isothermal chamber for 15 minutes so as to stabilize the temperature thereof. After the temperature of the liquid crystal display panel was stabilized, the measurement was performed.

Since fluctuation of the optical transmissivity is faint, stabilized supplies were utilized for signal sources 27, 28 for preventing the measurement of the optical transmissivity from being affected by these signal sources. On the other hand, the waveform of a alternating driver voltage being outputted from the signal voltage source 28 was set as a rectangular waveform of 30 Hz. This alternating driving voltage is applied between each of the pixel electrodes and each of the counter electrodes of the liquid crystal display panel, and the measurement of this experiment was performed under the same driving condition as that for a practical liquid crystal display device.

The measurement was performed by a sequence of (1) increasing the driving voltage (the aforementioned alternating driver voltage) from 0V to 8V for measuring the aforementioned T-V curve (Tb), (2) keeping the driving voltage at 8V for 30 minutes, and (3) dropping the driving voltage from 8V to 0V for measuring the T-V curve (Ta). The measurements were held at intervals of 0.1V in the range between 0V and 8V so as to obtain the T-V curves using 162 measured points in the increasing voltage direction and in the decreasing voltage direction.

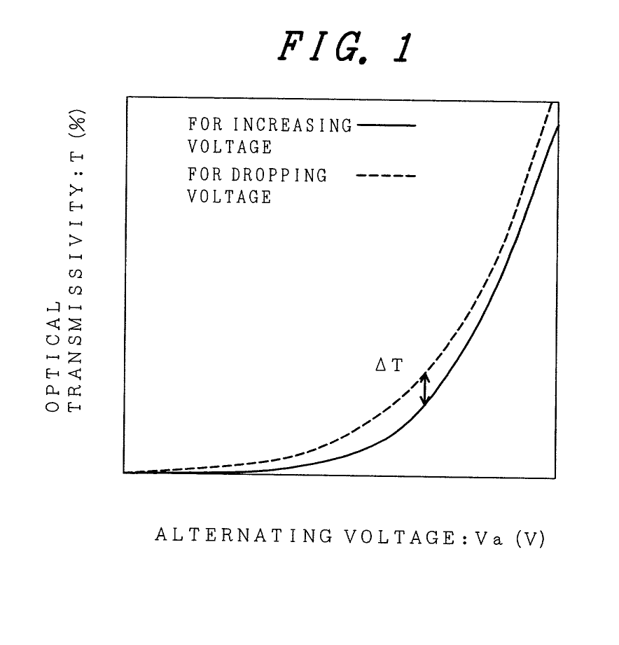

The T (Optical Transmissivity)−V (Driving Voltage) curves obtained by the foregoing measurements are shown in FIG. 1.

The magnitude of the sticking image phenomenon at the designated voltage Va is given by a transmissivity difference δT(Va), which is defined by following equation (1).

δT(Va)=|Ta(Va)−Tb(Va) (1)

This measurement resulted in δT(Va)=0.6(%). The value of 0.6(%) was obtained under a precision of 0.01% for measuring the optical transmissivity, and the sticking image phenomenon will be suppressed even more as this value as the transmissivity difference becomes lower.

<Physical Properties of the Alignment Film 3>

Using the same measurement as described above, a difference in the relative transmissivities was obtained. As mentioned above, the relative transmissivity is defined by the following equation (2) by using the transmissivity difference δT(Va) at an evaluation voltage in a range of the driving voltage in which the maximum transmissivity varies from 0 to 90%.

|ΔT(Va)|=δT(Va)/Tb(Va)×100 (2)

The difference in the relative transmissivity ΔT(VA) for the evaluating voltage Va is obtained by this equation (2). This measurement resulted in ΔT(Va)=6(%). The value of 0.6(%) was obtained under a precision of 0.01% for measuring the optical transmissivity, and the sticking image phenomenon will be suppressed even more as this value as the transmissivity difference becomes lower.

<Physical Properties of the Alignment Film 4>

The liquid crystal display panel was taken out of the liquid crystal display device, and a sealed portion, where a pair of substrates adhere to one another, and a liquid crystal injection port of the liquid crystal display panel were cut off using a glass cutter. Then, the pair of substrates were separated from one another, and the liquid crystal substance stained on the substrate was washed off using acetone or the like. After drying the surface of the separated substrate of the liquid crystal display panel sufficiently, the alignment film was peeled away from the substrate.

A surface of the alignment film was measured using an atomic force microscope operated in a contact mode thereof. FIG. 8(a) shows the basic structure of the atomic force microscope. The atomic force microscope comprises an cantilever 30, a probe 31 disposed at one end of the cantilever, a piezoelectric element to which the other end of the cantilever is fixed, an optical source 33 for irradiating a light beam onto an upper surface of the one end of the cantilever, and a photo diode array 34 for receiving the light beam reflected by the upper surface of the one end of the cantilever. The distance between the surface of the alignment film 10, as a specimen, and the probe 31 is controlled by the piezoelectric element 32. This distance and a bending amount (a flexibility) of the cantilever are measured by the photo diode array 34. An outline of the measurement performed in the contact mode by the atomic force microscope is described in the article NanoScope III AFM (Product of Digital Instruments, Co. Ltd.) on the Application Note 012 issued from Toyo Technica, Co. Ltd.

The experiment was performed at a temperature of 55° C., at a humidity of 50%, and a force curve according to a flexure of the cantilever 30 was measured by pushing the probe 31 into the aforementioned alignment film 10 in the manner shown in FIG. 8(b). As a result of the experiment, a ratio of the flexibility of the cantilever (x) and a penetration amount thereof (ΔL) was obtained as x/ΔL=about 1.26, and a modulus of elasticity (G) of the alignment layer was calculated as 1.8 GPa (1.8×10⁹N/m²) using the ratio of x/ΔL and a spring modulus of the cantilever (13N/m) under a measurement error of ±0.01.

The modulus of elasticity (G) was calculated on the basis of the following equation (3).

G=(k·LS)·(x/ΔL) (3)

In the equation (3), k denotes the spring modulus of the cantilever, ΔL denotes the penetration amount of the cantilever, and x denotes the flexibility of the cantilever. On the other hand, the length (L) of a scanning region of the probe 31 was 25 nm, the contacting area (S) of the probe with the alignment film 10 was 50 nm×50 nm, and the scanning frequency of the probe was 3.9 Hz.

Relying upon the foregoing experimental results, it was ascertained that the modulus of elasticity of the alignment film should be at least 1.8 GPa (1.8×10⁹N/m²) when measured at a temperature of 55° C. and under a measurement error of ±0.01 GPa. It was also ascertained that as the modulus of elasticity measured under this error becomes greater then 1.8 GPa, the magnitude of the sticking image problem on the screen decreases. Thus, alignment films having a modulus of elasticity such as 2 GPa (2×10⁹N/m²), 2.5 GPa (2.5×10⁹N/m²), 3 GPa (3×10⁹N/m²), 3.5 GPa (3.5×10⁹N/m²), 4 GPa (4×10⁹N/m²), 4.5 GPa (4.5×10⁹N/m²), 5 GPa (5×10⁹N/m²), . . . at a temperature of 55° C. may be utilized as well.

<Physical Properties of the Conventional Alignment Film>

FIG. 5 shows a deviation between the aforementioned T (Optical Transmissivity)−V (Driving Voltage) curves of the conventional liquid crystal display device for both an increasing driving voltage and a decreasing driving voltage, nearby the driving voltage of 0V. The modulus of elasticity of the alignment layer thereof was 0.01 GPa (0.01×10⁹N/m²). The image retention for changing images lasted for several hours. This image retention was evaluated as a transmissivity difference of 0.7% and a relative transmissivity difference of 7%, by setting the driving voltage at a value corresponding to a tone to which the naked eye is most sensitive.

Although the preceding embodiment utilized a liquid crystal display device of the lateral electric field type, the present invention should be not limited thereto. For instance, the present invention can be applied to liquid crystal display devices of the so-called vertical electric field type, pixel regions of which are composed by forming transparent electrodes on both sides of a pair transparent substrates which sandwich a liquid crystal layer therebetween and control optical transmissivity of the liquid crystal layer between the transparent electrodes.

As apparent from the foregoing explanation, the liquid crystal display device according to the present invention significantly suppresses the sticking image problem appearing in images displayed thereby.

While we have shown and described several embodiments in accordance with the present invention, it is understood that the same is not limited thereto, but is susceptible of numerous changes and modifications as known to those skilled in the art, and we therefore do not wish to be limited to the details shown and described herein, but intend to cover all such changes and modifications as are encompassed by the scope of the appended claims.

What is claimed is:

1. A liquid crystal display device comprising:
a pair of substrates and a liquid crystal layer interposed therebetween; and
at least one alignment film disposed between one of the pair of substrates and the liquid crystal layer;
wherein the at least one alignment film has a modulus of elasticity which is not less than 2 GPa (2×10⁹N/m²), a value of which is measured with a measurement error of ±1 GPa at a temperature of 55° C., including a fluctuation of ±5° C.

2. A liquid crystal display device comprising:
a pair of substrates and a liquid crystal layer interposed therebetween; and
at least one alignment film disposed between one of the pair of substrates and the liquid crystal layer;
wherein the at least one alignment film has a modulus of elasticity which is not less than 1.8 GPa (1.8×10⁹N/m²), a value of which is measured with a measurement error of ±0.01 GPa at a temperature of 55° C., including a fluctuation of ±5° C.

3. A liquid crystal display device comprising:
a pair of substrates and a liquid crystal layer interposed therebetween; and
at least one alignment film disposed between one of the pair of substrates and the liquid crystal layer;
wherein the at least one alignment film includes at least one polycrystalline region formed therein, and the polycrystalline region contains crystal grains of at least one polymeric material utilized for an ingredient of the alignment film.

4. A liquid crystal display device comprising:
a pair of substrates;
a liquid crystal layer interposed between the pair of substrates;
wherein the liquid crystal display device exhibits a difference between optical transmissivities thereof, in accordance with a driving voltage applied thereto for increasing the driving voltage and for decreasing the driving voltage, which does not exceed 0.6%, while a measurement error for each of the optical transmissivities is ±0.01% or less.

5. A liquid crystal display device according to claim 4, wherein at least one alignment film is disposed between one of the pair of substrates and the liquid crystal layer.

6. A liquid crystal display device comprising:
a pair of substrates; and
a liquid crystal layer being interposed between the pair of substrates;
wherein the liquid crystal display device exhibits a relative optical transmissivity difference, which is determined as a deviation ratio of the optical transmissivity thereof for a decreasing driving voltage being supplied thereto to that for an increasing driving voltage in accordance with the driving voltage, which does not exceed 6%, while a measurement error for each of the optical transmissivities is ±0.01% or less.

7. A liquid crystal display device according to claim 6, wherein at least one alignment film is disposed between one of the pair of substrates and the liquid crystal layer.

8. A liquid crystal display device according to one of claims 1, 2, 3, 5, and 7, further comprising:
at least one pixel electrode disposed between the at least one alignment film and the one of the pair of substrates; and
at least one counter electrode disposed between the at least one alignment film and the one of the pair of substrates;
wherein the at least one pixel electrode and at least one counter electrode are spaced from one another so as to generate an electric field for controlling the optical transmissivity of the liquid crystal layer.

9. A liquid crystal display device according to claim 8, further comprising:
at least one switching element disposed between the at least one alignment film and the one of the pair of substrates and being connected to the at least one pixel electrode;
at least one video signal line for supplying a signal to the at least one pixel electrode through the at least one switching element and being disposed between the at least one alignment film and the one of the pair of substrates; and
at least one counter voltage signal line for supplying a signal to the at least one counter electrode and being disposed between the at least one alignment film and the one of the pair of substrates.

10. A liquid crystal display device according to claim 9, further comprising:
at least one scanning signal line for transmitting a signal to switch the at least one switching element and being disposed between the at least one alignment film and the one of the pair of substrates.

11. A liquid crystal display device according to one of claims 1, 2, 3, 4, and 6, further comprising:
at least one first electrode disposed between the liquid crystal layer and the one of the pair of substrates; and
at least one second electrode disposed between the liquid crystal layer and the other of the pair of substrates;
wherein an optical transmissivity of the liquid crystal layer is modulated by an electric field applied between the at least one first electrode and the at least one second electrode.
